(19) United States
(12) Patent Application Publication
(10) Pub. No.: US 2026/0004726 A1
(43) Pub. Date: Jan. 1, 2026

(54) Processing method, system, device and medium for brightness compensation of display screen

(71) Applicant: Hefei University of Technology, Hefei (CN)

(72) Inventors: Qibin FENG, Hefei (CN); Hongtao REN, Hefei (CN); Guoqiang LV, Hefei (CN); Zi WANG, Hefei (CN)

(73) Assignee: Hefei University of Technology, Hefei (CN)

(21) Appl. No.: 19/239,917

(22) Filed: Jun. 16, 2025

Related U.S. Application Data
(63) Continuation of application No. PCT/CN2025/073837, filed on Jan. 22, 2025.

(30) Foreign Application Priority Data
Jun. 26, 2024 (CN) 202410839621.2

(51) Int. Cl. G09G 3/3225

(52) U.S. Cl. CPC G09G 3/3225; G09G 2320/041; G09G 2320/0626

(57) ABSTRACT

A processing method of a display screen brightness compensation includes: obtaining a sample data set of the display screen, a real environment temperature and a real image average grayscale value corresponding to the real environment temperature, the sample data set including an environment temperature sample set, a image average grayscale sample set corresponding to the environment temperature sample set and a simulated temperature sample set; performing a linear regression processing on the sample data set to generate a regression coefficient set; processing the real environment temperature and the real image average grayscale value according to the regression coefficient set to generate a temperature to be compensated of the display screen; and determining a brightness compensation parameter according to the temperature to be compensated, and performing a brightness compensation processing on the display screen according to the brightness compensation parameter.

### CROSS REFERENCE TO RELATED APPLICATION

The present application is a continuation Application of PCT application No. PCT/CN2025/073837 filed on Jan. 22, 2025, which claims the benefit of CN2024108396212 filed on Jun. 26, 2024. All the above are hereby incorporated by reference for all purposes.

### TECHNICAL FIELD

The disclosure relates to a display screen, and in particular to a processing method, a system, device and medium for brightness compensation of the display screen.

### BACKGROUND

Display screens based on silicon-based organic light emitting displays (OLED) have the advantages of small size, low power consumption and high resolution, and are widely used in head-mounted displays, medical, industrial and military fields.

### SUMMARY

One or more embodiments of the disclosure provide a processing method for brightness compensation of a display screen, which includes operations as follows.

A sample data set of the display screen, a real environment temperature of the display screen and a real image average grayscale value corresponding to the real environment temperature are obtained. The sample data set includes an environment temperature sample set, an image average grayscale sample set corresponding to the environment temperature sample set and a simulated temperature sample set.

A linear regression processing on the sample data set is performed to generate a regression coefficient set.

The real environment temperature and the real image average grayscale value are processed according to the regression coefficient set to generate a temperature to be compensated of the display screen.

A brightness compensation parameter is determined according to the temperature to be compensated, and a brightness compensation processing is performed on the display screen according to the brightness compensation parameter.

In an embodiment of the disclosure, obtaining a sample data set of the display screen, a real environment temperature and a corresponding real image average grayscale value includes operations as follows.

The sample data set of the display screen is obtained.

The real environment temperature of the display screen is obtained.

A resolution of the display screen and the grayscale values of all pixels in the display image at the real environment temperature are obtained, and the resolution and the grayscale values are processed to generate the real image average grayscale value.

In an embodiment of the disclosure, performing the linear regression processing on the sample data set to generate a regression coefficient set includes operations as follows.

The environment temperature sample set, the image average grayscale sample set and the simulated temperature sample set are respectively averaged to generate an environment temperature average value, an image average grayscale average value and a simulated temperature average value.

The environment temperature sample set, the image average grayscale sample set and the simulated temperature sample set are processed in sequence according to the environment temperature average value, the image average grayscale average value and the simulated temperature average value to generate an undetermined coefficient set.

A binary linear regression processing is performed on the undetermined coefficient set to generate the regression coefficient set.

In an embodiment of the disclosure, respectively averaging the environment temperature sample set, the image average grayscale sample set and the simulated temperature sample set satisfies a formula:

$$\overline{T} = \frac{1}{p * k} {\sum }_{i = 1}^{p * k} {T}_{i} ,$$

$$\overline{L} = \frac{1}{p * k} {\sum }_{i = 1}^{p * k} {L}_{i} ,$$

$$\overline{{T}_{OLED}} = \frac{1}{p * k} {\sum }_{i = 1}^{p * k} {T}_{{OLED}_{i}} ,$$

wherein, p represents a number of environment temperature samples in the environment temperature sample set, k represents a number of image average grayscale samples in the image average grayscale sample set, Tᵢ represents an i-th environment temperature sample in the environment temperature sample set, T̅ represents the environment temperature average value, Lᵢ represents an i-th image average grayscale sample in the image average grayscale sample set, L̅ represents the image average grayscale average value, T_{OLED}_{ᵢ} represents an i-th simulated temperature sample in the simulated temperature sample set, and T̅_̅{̅O̅L̅E̅D̅}̅ represents the simulated temperature average value.

In an embodiment of the disclosure, processing the environment temperature sample set, the image average grayscale sample set, and the simulated temperature sample in sequence according to the environment temperature average value, the image average grayscale average value and the simulated temperature sample set satisfies a formula:

$${l}_{11} = {\sum }_{i = 1}^{p * k} {( {L}_{i} - \overline{L} )}^{2} ,$$

$${l}_{22} = {\sum }_{i = 1}^{p * k} {( {T}_{i} - \overline{T} )}^{2} ,$$

$${l}_{12} = {l}_{21} = {l}_{11} = {\sum }_{i = 1}^{p * k} ( {L}_{i} - \overline{L} ) ( {T}_{i} - \overline{T} ) ,$$

$${l}_{10} = {l}_{11} = {\sum }_{i = 1}^{p * k} ( {L}_{i} - \overline{L} ) ( {T}_{{OLED}_{i}} - \overline{{T}_{OLED}} ) ,$$

$${l}_{20} = {\sum }_{i = 1}^{p * k} ( {T}_{i} - \overline{T} ) ( {T}_{{OLED}_{i}} - \overline{{T}_{OLED}} ) ,$$

wherein, p represents a number of environment temperature samples in the environment temperature sample set, k represents a number of image average grayscale samples in the image average grayscale sample set, Tᵢ represents an i-th environment temperature sample in the environment temperature sample set, T̅ represents the environment temperature average value, Lᵢ represents an i-th image average grayscale sample in the image average grayscale sample set, L represents the image average grayscale average value, T_{OLED}_{ᵢ} represents an i-th simulated temperature sample in the simulated temperature sample set, and T̅_̅{̅O̅L̅E̅D̅}̅ represents the simulated temperature average value, l₁₁, l₂₂, l₁₂, l₂₁, l₁₀ and l₂₀ respectively represent undetermined coefficients in the undetermined coefficient set.

In an embodiment of the disclosure, the regression coefficient set includes an image grayscale regression coefficient, an environment temperature regression coefficient and a temperature compensation coefficient, and the binary linear regression processing of the undetermined coefficient set satisfies a formula:

$$\{ \begin{matrix}{l}_{11} {C}_{1} + {l}_{12} {C}_{2} = {l}_{10} \\ {l}_{21} {C}_{1} + {l}_{22} {C}_{2} = {l}_{20}\end{matrix} ,$$

$${C}_{3} = \overline{{T}_{OLED}} - {C}_{1} \overline{L} - {C}_{2} \overline{T} ,$$

wherein, l₁₁, l₂₂, l₁₂, l₂₁, l₁₀ and l₂₀ respectively represent the undetermined coefficients in the undetermined coefficient set, C₁ is the image grayscale regression coefficient, C₂ is the environment temperature regression coefficient, and C₃ is the temperature compensation coefficient.

In an embodiment of the disclosure, processing the real environment temperature and the real image average grayscale value according to the regression coefficient set to satisfy a formula:

$${T}_{OLED}^{′} = {C}_{3} + {C}_{1} {L}^{′} + {C}_{2} {T}^{′}$$

Wherein, C₁ represents the image grayscale regression coefficient, C₁ represents the environment temperature regression coefficient, C₁ represents the temperature compensation coefficient, T′ represents the real environment temperature, L′ represents the real image average grayscale value, and T′_{OLED} represents a temperature to be compensated of the display screen.

One or more embodiments of the disclosure further provide a processing system for brightness compensation of the display screen, which includes a data acquisition module, a linear regression module, a temperature generation module, a temperature generation module and a brightness compensation module.

The data acquisition module is configured to obtain a sample data set of the display screen, a real environment temperature of the display screen and a corresponding real image average grayscale value, and the sample data set includes an environment temperature sample set, a corresponding image average grayscale sample set and a simulated temperature sample set.

The linear regression module is configured to perform a linear regression processing on the sample data set to generate a regression coefficient set.

The temperature generation module is configured to process the real environment temperature and the real image average grayscale value according to the regression coefficient set to generate a temperature to be compensated of the display screen.

The brightness compensation module is configured to determine a brightness compensation parameter according to the temperature to be compensated, and perform a brightness compensation processing on the display screen according to the brightness compensation parameter.

The disclosure further provides an electronic device, which includes one or more processors and a storage system.

The storage system is configured to store one or more programs. When the one or more programs are executed by the one or more processors, the storage system enables the electronic device to implement the processing method for brightness compensation of the display screen mentioned above.

The disclosure further provides a non-transitory computer-readable storage medium. A computer program is stored on the non-transitory computer-readable storage medium, and when the computer program is executed by a processor of a computer, the computer is adapted to implement the processing method for brightness compensation of the display screen mentioned above.

### BRIEF DESCRIPTION OF THE DRAWINGS

In order to explain technical solutions of embodiments of the disclosure more clearly, the following will briefly introduce drawings used in a description of the embodiments or the conventional art. Obviously, the drawings in the following description are only some embodiments of the disclosure. For those of ordinary skill in the art, other drawings may be obtained based on these drawings without creative work.

FIG. 1 is a schematic flowchart of a processing method of a display screen brightness compensation according to at least one embodiment of the disclosure.

FIG. 2 is a flowchart of S100 in an embodiment shown in FIG. 1 according to at least one embodiment of the disclosure.

FIG. 3 is a schematic structural view of a simulation model of the display screen in FIG. 2.

FIG. 4 is an enlarged view of area A in FIG. 3 of the disclosure.

FIG. 5 is a flowchart of S200 in an embodiment shown in FIG. 1 according to at least one embodiment of the disclosure.

FIG. 6 is a schematic view of a processing system for brightness compensation of the display screen shown in an embodiment in FIG. 1.

FIG. 7 is a schematic structural view of a computer system of an electronic device used to implement an embodiment of the disclosure.

### PART NUMBER DESCRIPTION

101—glass cover board; 102—optical transparent adhesive; 103—color optical filter; 104—thin film package layer; 105—screen light-emitting layer; 106—silicon-based back board.

### DETAILED DESCRIPTION

The following will be combined with the accompanying drawings in embodiments of the disclosure to clearly and completely describe technical solutions in the embodiments of the disclosure. Obviously, the described embodiments are only part of the embodiments of the disclosure, not all of the embodiments. Based on the embodiments of the disclosure, all other embodiments obtained by ordinary technicians in this field without making any creative work shall fall within a scope of protection of the disclosure.

Since the luminescence of OLED display screens depends on the migration and recombination of organic carriers, and the carrier concentration in semiconductors is related to temperature, which causes that the carrier migration has obvious temperature characteristics. In high and low temperature environments, the brightness of OLED light will change greatly, which seriously affects the display effect.

In order to stabilize the display brightness of silicon-based OLED display screens at different environment temperatures, the conventional technology usually only performs a temperature compensation based on the environment temperature around the silicon-based OLED display screen. However, since most of the input power of the OLED display screen is converted into heat, the temperature of the OLED display screen itself will be significantly higher than the environment temperature, which results in low accuracy and large errors in the conventional temperature compensation technology. Therefore, it may still be improved.

The disclosure provides a processing method, a system, device and medium for brightness compensation of the display screen which may improve a problem of low accuracy and large error in a conventional brightness compensation of display screens through an environment temperature.

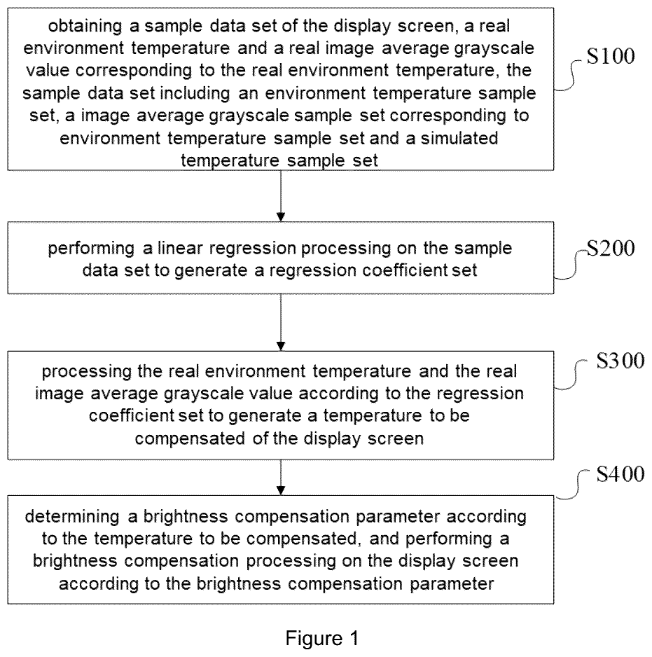

Please refer to FIG. 1 through FIG. 5. The disclosure provides a processing method, system, device and medium of a display screen brightness compensation, which relates to a field of display technology and may be specifically applied to improve a problem that an OLED (Organic Light Emitting Display) display screen has a poor brightness compensation effect through an environment temperature.

Please refer to FIG. 1. The disclosure provides a schematic flowchart of the processing method for brightness compensation of the display screen. In an embodiment of the disclosure, the processing method for display screen brightness compensation may include operations S100 to S500, which are described in detail as follows.

S100: a sample data set of the display screen, a real environment temperature and a real image average grayscale value corresponding to the real environment temperature are obtained. The sample data set includes an environment temperature sample set, an image average grayscale sample set corresponding to environment temperature sample set the and a simulated temperature sample set.

S200: a linear regression processing on the sample data set is performed to generate a regression coefficient set.

S300: the real environment temperature and the real image average grayscale value are processed according to the regression coefficient set to generate a temperature to be compensated of the display screen.

S400: a brightness compensation parameter is determined according to the temperature to be compensated, and a brightness compensation processing is performed on the display screen according to the brightness compensation parameter.

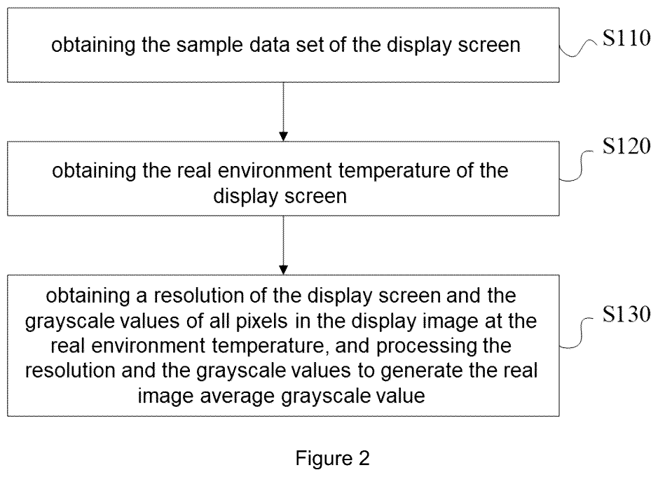

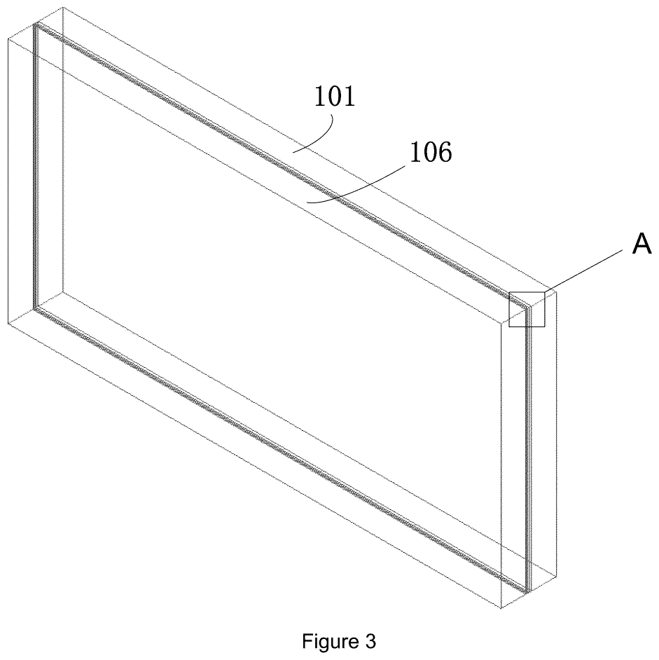

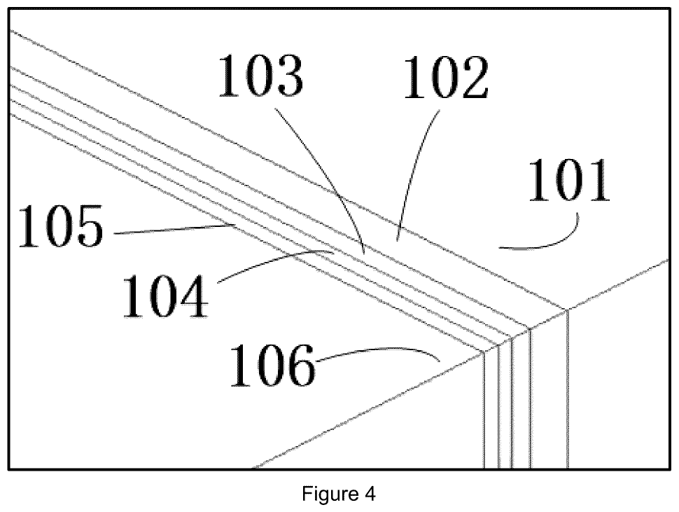

Please refer to FIG. 1, FIG. 2, FIG. 3 and FIG. 4. In an embodiment of the disclosure, when executing S100, it means that a sample data set of the display screen, a real environment temperature and a corresponding real image average grayscale value are obtained. In an embodiment, S100 may include operations S110 to S130, which are described in detail as follows.

S110: the sample data set of the display screen is obtained.

S120: the real environment temperature of the display screen is obtained.

S130: a resolution of the display screen and a grayscale values of all pixels in a display image at the real environment temperature are obtained, and the resolution and the grayscale values are processed to generate the real image average grayscale value.

Please refer to FIG. 1 and FIG. 2. In an embodiment of the disclosure, when executing S110, the display screen may be a silicon-based organic light emitting diode (OLED), and the sample data set of the display screen may be obtained in a variety of ways. However, the disclosure is not limited thereto, and the display screen may also be other types of display screens. But it should be noted that, in this disclosure, the display screen refers to a small-sized silicon-based OLED display screen.

Please refer to FIG. 3 and FIG. 4. For example, through establishing a simulation model of a silicon-based OLED display screen, the environment temperature sample set of the display screen, the corresponding image average grayscale sample set, and the simulated temperature sample set may be obtained. In an embodiment, an actual structure of the silicon-based OLED display screen may be processed equivalently, and a simulation model may be established based on a membrane layer function of the display screen and its sensitivity to temperature.

A size of the simulation model is an actual size of the display screen. A structure of the simulation model may include but is not limited to a glass cover board 101, an optical transparent adhesive 102, a color optical filter 103, a thin film package layer 104, a screen light-emitting layer 105 and a silicon-based back board 106, and the glass cover board 101, the optical transparent adhesive 102, the color optical filter 103, the thin film package layer 104, the screen light-emitting layer 105 and the silicon-based back board 106 may be stacked in sequence. For example, a diagonal length of the simulation model of the display screen may be 1.3 inches, a thickness of the glass cover board 101 may be 700 μm, a thickness of the optical transparent adhesive 102 may be 5 μm, a thickness of the color optical filter 103 may be 2.5 μm, a thickness of the thin film package layer 104 may be 2 μm, a thickness of the screen light-emitting layer 105 may be 2 μm, and a thickness of the silicon-based back board 106 may be 750 μm.

Further, in the simulation model of the display screen, a temperature of the simulation model may be set to a steady-state analysis, and material parameters of a structure in the simulation model only set a thermal conductivity, and the thermal conductivity of each material is set to a constant to simplify a complexity of a temperature distribution calculation of the simulation model and improve a simulation speed. The material parameters of the structure in the simulation model are shown in Table 1.

TABLE 1
material parameters of the structure in the simulation model

| Structure | Material | Thermal conductivity |
|---|---|---|
| Glass cover board | Glass | 1.1 |
| Optical transparent | Optical transparent | 0.25 |
| adhesive | adhesive | |
| Color optical filter | Organic dyes and | 0.2 |
| | resins | |
| Thin film package layer | Olefin materials | 0.24 |
| Screen light-emitting layer | Alq3 | 0.107 |
| Silicon-based back board | Silicon | 143 |

Further, input parameters of the simulation model may be power consumption of the screen light-emitting layer 105 and the environment temperature sample set. The power consumption of the screen light-emitting layer 105 may be determined by a driving power of the simulation model, the image average grayscale sample, and energy conversion efficiency. In an embodiment, the driving power may be set to 180 mW, the energy conversion efficiency may be set to 5%, a range of the environment temperature sample set of the simulation model may be between −20° C. and 60° C., and a range of the image average grayscale sample set may be between 0 and 255. For example, the environment temperature samples of the simulation model may be −20° C., 60° C., or 20° C. The image average grayscale sample may be 0, 255, or 150. In addition, convections may further be set on a contact surface between the glass cover board 101 and air, and on a contact surface between the silicon-based back board 106 and the air, and a convection heat transfer coefficient of natural convection heat transfer of the air may be 5 W/mm²·° C. to achieve a heat conduction between the simulation model and environment.

It is worth further explaining that a number of environment temperature samples included in the environment temperature sample set may not be specifically limited. For example, a range of the environment temperature sample set may be from −20° C. to 60° C., and the environment temperature sample set may include 9 environment temperature samples. A number of image average grayscale samples included in the image average grayscale sample set may not be specifically limited. For example, a range of the image average grayscale sample set may be from 0 to 255, and the image average grayscale sample set may include 6 image average grayscale samples. Wherein, under each environment temperature sample, there may be a plurality of different image average grayscale samples corresponding to each environment temperature sample, a corresponding simulated temperature sample may be generated according to each environment temperature sample and its corresponding image average grayscale sample, and all simulated temperature samples constitute a simulated temperature sample set. A relationship between the environment temperature samples, image average grayscale samples and simulated temperature samples under the simulation model is shown in Table 2.

TABLE 2
relationship between the environment temperature samples,
image average grayscale samples and simulated temperature
samples under the simulation model

| Environment | | | | | | |
|---|---|---|---|---|---|---|
| temperature | simulated temperature sample (° C.) | | | | | |
| sample (° C.) | 255 | 200 | 150 | 100 | 50 | 0 |
| −20 | −2.127 | −5.983 | −9.487 | −12.991 | −16.496 | −20 |
| −10 | 7.873 | 4.017 | 0.513 | −2.991 | −6.496 | −10 |
| 0 | 17.873 | 14.017 | 10.513 | 7.009 | 3.504 | 0 |
| 10 | 27.873 | 24.017 | 20.513 | 17.009 | 13.504 | 10 |
| 20 | 37.873 | 34.017 | 30.513 | 27.009 | 23.504 | 20 |
| 30 | 47.873 | 44.017 | 40.513 | 37.009 | 33.504 | 30 |
| 40 | 57.873 | 54.017 | 50.513 | 47.009 | 43.504 | 40 |
| 50 | 67.873 | 64.017 | 60.513 | 57.009 | 53.504 | 50 |
| 60 | 77.873 | 74.017 | 70.513 | 67.009 | 63.504 | 60 |

However, the disclosure is not limited thereto, and a test system for a silicon-based OLED display screen may be built to obtain the environment temperature sample set of the display screen, the corresponding image average grayscale sample set, and the simulated temperature sample set. In an embodiment, a resistance strain gauge may be bonded to a surface of the display screen and connected to a strain gauge device to build the test system for the silicon-based OLED display screen.

Further, after building the test system for the silicon-based OLED display screen, the test system further needs to be placed in a high and low temperature test chamber to test and obtain simulated temperature samples of the silicon-based OLED display screen under different environment temperature samples and different image average grayscale samples. In an embodiment, a relationship between the environment temperature samples, image average grayscale samples and simulated temperature samples in the test system is shown in Table 3.

TABLE 3
relationship between the environment temperature
samples, image average grayscale samples and simulated
temperature samples in the test system

| Environment | | | | | | |
|---|---|---|---|---|---|---|
| temperature | Simulated temperature sample (° C.) | | | | | |
| sample (° C.) | 255 | 200 | 150 | 100 | 50 | 0 |
| −20 | −2.247 | −6.076 | −9.558 | −13.038 | −16.519 | −20 |
| −10 | 7.753 | 3.924 | 0.443 | −3.038 | −6.519 | −10 |
| 0 | 17.753 | 13.924 | 10.443 | 6.962 | 3.481 | 0 |
| 10 | 27.753 | 23.924 | 20.443 | 16.962 | 13.481 | 10 |
| 20 | 37.753 | 33.924 | 30.443 | 26.962 | 23.481 | 20 |
| 30 | 47.753 | 43.924 | 40.443 | 36.962 | 33.481 | 30 |
| 40 | 57.753 | 53.924 | 50.443 | 46.962 | 43.481 | 40 |
| 50 | 67.753 | 63.924 | 60.443 | 56.962 | 53.481 | 50 |
| 60 | 77.753 | 73.924 | 70.443 | 66.962 | 63.481 | 60 |

Please refer to FIG. 1 and FIG. 2. In an embodiment of the disclosure, when executing S120 to S130, the actual environment temperature of the display screen may be obtained through a temperature sensor. The resolution of the display screen is a preset value, and the display screen may be placed at a real environment temperature to obtain the grayscale values of all pixels in an image displayed on the display screen. The resolution and grayscale value are processed to obtain the real image average grayscale value on the display screen. Wherein, processing the resolution and grayscale value may satisfy a following formula:

$$L = \frac{{L}_{( 1 , 1 )} + ⋯ + {L}_{( i , j )}}{M \times N} ,$$

Wherein, M×N may represent the resolution of the display screen, L(1,1) may represent a grayscale value of the (1,1)th pixel in a displayed image, L(i, j) may represent a grayscale value of the (i, j)th pixel in the displayed image, and i=1˜M, j=1˜N, and L may represent the real image average grayscale value.

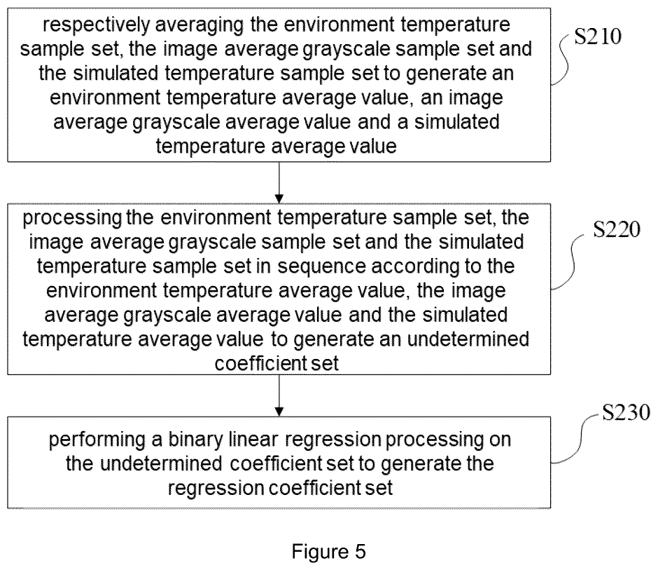

Please refer to FIG. 1 and FIG. 5. In an embodiment of the disclosure, when executing S200, it means the linear regression processing on the sample data set is processed to generate a regression coefficient set. In an embodiment, S200 may include operations S210 to S230, which are described in detail as follows.

S210: the environment temperature sample set, the image average grayscale sample set and the simulated temperature sample set are respectively averaged to generate an environment temperature average value, an image average grayscale average value and a simulated temperature average value.

S220: the environment temperature sample set, the image average grayscale sample set and the simulated temperature sample set is processed in sequence according to the environment temperature average value, the image average grayscale average value and the simulated temperature average value to generate an undetermined coefficient set.

S230: a binary linear regression processing is performed on the undetermined coefficient set to generate the regression coefficient set.

In an embodiment of the disclosure, when executing S210, an averaging process of the environment temperature sample set, the image average grayscale sample set, and the simulated temperature sample set satisfies a formula:

$$\overline{T} = \frac{1}{p * k} {\sum }_{i = 1}^{p * k} {T}_{i} ,$$

$$\overline{L} = \frac{1}{p * k} {\sum }_{i = 1}^{p * k} {L}_{i} ,$$

$$\overline{{T}_{OLED}} = \frac{1}{p * k} {\sum }_{i = 1}^{p * k} {T}_{{OLED}_{i}} ,$$

wherein, p represents a number of environment temperature samples in the environment temperature sample set, k represents a number of image average grayscale samples in the image average grayscale sample set, Tᵢ represents an i-th environment temperature sample in the environment temperature sample set, T̅ represents the environment temperature average value, Lᵢ represents an i-th image average grayscale sample in the image average grayscale sample set, L̅ represents the image average grayscale average value, T_{OLED}_{ᵢ} represents an i-th simulated temperature sample in the simulated temperature sample set, and T̅_̅{̅O̅L̅E̅D̅}̅ represents the simulated temperature average value.

In an embodiment of the disclosure, when executing S220, processing the environment temperature sample set, the image average grayscale sample set, and the simulated temperature sample in sequence according to the environment temperature average value, the image average grayscale average value and the simulated temperature sample set satisfies a formula:

$${l}_{11} = {\sum }_{i = 1}^{p * k} {( {L}_{i} - \overline{L} )}^{2} ,$$

$${l}_{22} = {\sum }_{i = 1}^{p * k} {( {T}_{i} - \overline{T} )}^{2} ,$$

$${l}_{12} = {l}_{21} = {l}_{11} = {\sum }_{i = 1}^{p * k} ( {L}_{i} - \overline{L} ) ( {T}_{i} - \overline{T} ) ,$$

$${l}_{10} = {l}_{11} = {\sum }_{i = 1}^{p * k} ( {L}_{i} - \overline{L} ) ( {T}_{{OLED}_{i}} - \overline{{T}_{OLED}} ) ,$$

$${l}_{20} = {\sum }_{i = 1}^{p * k} ( {T}_{i} - \overline{T} ) ( {T}_{{OLED}_{i}} - \overline{{T}_{OLED}} ) ,$$

wherein, p represents a number of environment temperature samples in the environment temperature sample set, k represents a number of image average grayscale samples in the image average grayscale sample set, Tᵢ represents an i-th environment temperature sample in the environment temperature sample set, T̅ represents the environment temperature average value, Lᵢ represents an i-th image average grayscale sample in the image average grayscale sample set, L̅ represents the image average grayscale average value, T_{OLED}_{ᵢ} represents an i-th simulated temperature sample in the simulated temperature sample set, and T̅_̅{̅O̅L̅E̅D̅}̅ represents the simulated temperature average value, l₁₁, l₂₂, l₁₂, l₂₁, l₁₀ and l₂₀ respectively represent undetermined coefficients in the undetermined coefficient set.

In an embodiment of the disclosure, when executing S230, the regression coefficient set includes an image grayscale regression coefficient, an environment temperature regression coefficient and a temperature compensation coefficient, and the binary linear regression processing of the undetermined coefficient set satisfies a formula:

$$\{ \begin{matrix}{l}_{11} {C}_{1} + {l}_{12} {C}_{2} = {l}_{10} \\ {l}_{21} {C}_{1} + {l}_{22} {C}_{2} = {l}_{20}\end{matrix} ,$$

$${C}_{3} = \overline{{T}_{OLED}} - {C}_{1} \overline{L} - {C}_{2} \overline{T} ,$$

wherein, l₁₁, l₂₂, l₁₂, l₂₁, l₁₀ and l₂₀ respectively represent the undetermined coefficients in the undetermined coefficient set, C₁ is the image grayscale regression coefficient, C₂ is the environment temperature regression coefficient, and C₃ is the temperature compensation coefficient.

Please refer to FIG. 1 and FIG. 4. In an embodiment of the disclosure, when executing S300, which means processing the real environment temperature and the real image average grayscale value according to the regression coefficient set, a temperature to be compensated of the display screen is generated. In an embodiment, processing the real environment temperature and the real image average grayscale value according to the regression coefficient set satisfies a formula:

$${T}_{OLED}^{′} = {C}_{3} + {C}_{1} {L}^{′} + {C}_{2} {T}^{′} ,$$

Wherein, C₁ represents the image grayscale regression coefficient, C₁ represents the environment temperature regression coefficient, C₁ represents the temperature compensation coefficient, T′ represents the real environment temperature, L′ represents the real image average grayscale value, and T′_{OLED} represents a temperature to be compensated of the display screen.

Please refer to FIG. 1. In an embodiment of the disclosure, when executing S400, after obtaining the temperature to be compensated, the brightness compensation parameter is determined according to the temperature to be compensated, and the brightness compensation processing is performed on the display screen according to the brightness compensation parameter. Wherein, the brightness compensation parameters refer to specific properties that need to be adjusted when performing the brightness compensation, and the brightness compensation parameters may include but are not limited to current adjustment values, color correction parameters, and brightness correction parameters. Since brightness of display screen pixels is controlled by adjusting current flowing through it, the current adjustment value is a slight adjustment of a current intensity of each pixel to compensate for an effect of temperature changes on brightness. As the temperature changes, a color balance of the display screen may also be affected. The color correction parameters involve adjusting RGB (red, green, blue) values to maintain accurate and consistent of color display. A brightness correction coefficient is a global parameter that is configured to adjust a brightness level of the entire display screen to maintain a user's desired brightness at different temperatures.

Further, performing brightness compensation processing on the display screen according to the brightness compensation parameters may include applying the obtained brightness compensation parameters to a driver of the display screen to adjust the current intensity and a color value of each pixel of the display screen in real time, thereby correctly compensating for an effect of temperature on the brightness of the display screen.

It may be seen that in the above embodiment, through obtaining a sample data set and performing the linear regression processing on the sample data set, the regression coefficient set is obtained, and then the real environment temperature and the real image average grayscale value are processed according to the regression coefficient set to obtain the temperature to be compensated of the display screen, so as to enable the temperature of the display screen for compensation to be closer to the actual temperature, thereby reducing an error of the brightness compensation of the display screen through the temperature and improving a brightness compensation accuracy of the display screen.

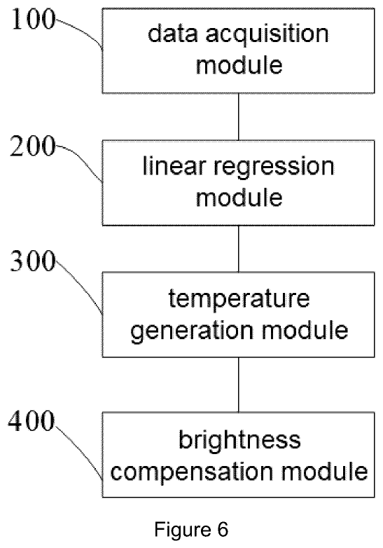

Please refer to FIG. 6. FIG. 6 is a processing system for display screen brightness compensation provided by the disclosure. The processing system may be applied to a processing method for display screen brightness compensation to improve the brightness compensation accuracy of the display screen. A processing flow of the processing system may correspond to a processing flow of the above-mentioned processing method. The processing system may include, but is not limited to, a data acquisition module 100, a linear regression module 200, a temperature generation module 300, and a brightness compensation module 400. Each functional module is described in detail as follows.

In an embodiment of the disclosure, the data acquisition module 100 may be configured to obtain the sample data set of the display screen, the real environment temperature and the corresponding real image average grayscale value, and the sample data set includes an environment temperature sample set, a corresponding image average grayscale sample set and a simulated temperature sample set.

In an embodiment of the disclosure, the linear regression module 200 may be configured to perform the linear regression processing on the sample data set to generate the regression coefficient set. Wherein, performing the linear regression processing on the sample data set includes respectively averaging the environment temperature sample set, the image average grayscale sample set and the simulated temperature sample set to generate the environment temperature average value, the image average grayscale average value and the simulated temperature average value. Then the environment temperature sample set, the image average grayscale sample set and the simulated temperature sample set is processed in sequence according to the environment temperature average value, the image average grayscale average value and the simulated temperature average value to generate an undetermined coefficient set. Finally, the binary linear regression processing is performed on the undetermined coefficient set to generate the regression coefficient set.

In an embodiment of the disclosure, the temperature generation module 300 may be configured to process the real environment temperature and the real image average grayscale value according to the regression coefficient set to generate the temperature to be compensated of the display screen. In an embodiment, processing the real environment temperature and the real image average grayscale value according to the regression coefficient set to satisfy a formula:

$${T}_{OLED}^{′} = {C}_{3} + {C}_{1} {L}^{′} + {C}_{2} {T}^{′} ,$$

Wherein, C₁ represents the image grayscale regression coefficient, C₁ represents the environment temperature regression coefficient, C₁ represents the temperature compensation coefficient, T′ represents the real environment temperature, L′ represents the real image average grayscale value, and T′_{OLED} represents a temperature to be compensated of the display screen.

In an embodiment of the disclosure, the brightness compensation module 400 may be configured to determine the brightness compensation parameter according to the temperature to be compensated, and perform the brightness compensation processing on the display screen according to the brightness compensation parameter. Wherein, the brightness compensation parameters refer to the specific properties that need to be adjusted when performing the brightness compensation, and the brightness compensation parameters may include but are not limited to the current adjustment values, the color correction parameters, and the brightness correction parameters. Since the brightness of display screen pixels is controlled by adjusting current flowing through it, the current adjustment value is the slight adjustment of the current intensity of each pixel to compensate for the effect of temperature changes on the brightness. As the temperature changes, the color balance of the display screen may also be affected. The color correction parameters involve adjusting RGB (red, green, blue) values to maintain accurate and consistent of the color display. The brightness correction coefficient is the global parameter that is configured to adjust the brightness level of the entire display screen to maintain the user's desired brightness at different temperatures.

The disclosure further provides an electronic device, which includes one or more processors and a storage system used to store one or more programs. When the one or more programs are executed by the one or more processors, the storage system enables the electronic device to implement the processing method for brightness compensation of the display screen mentioned above in the embodiments.

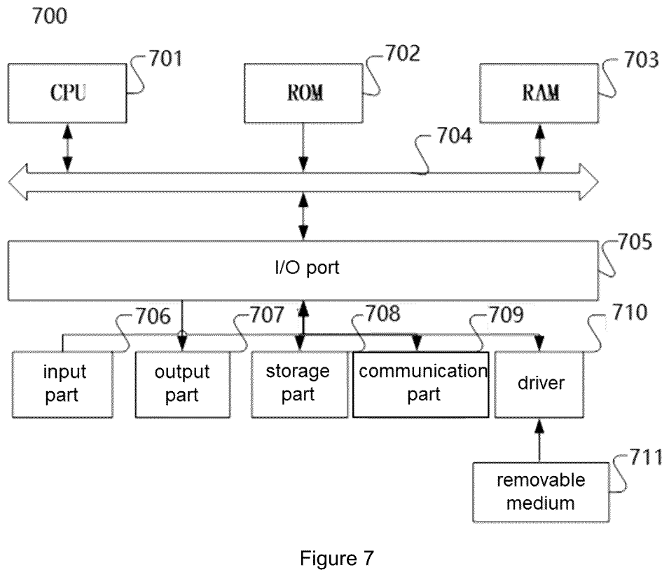

FIG. 7 is a schematic structural view of a computer system of the electronic device used to implement an embodiment of the disclosure. It should be noted that, the computer system 700 of the electronic device shown in FIG. 7 is only an example and should not limit functions and a scope of use of the embodiments of the disclosure.

Please refer to FIG. 7. The computer system 700 includes a central processing unit (CPU) 701, which may perform various appropriate actions and processes according to a program stored in a read-only memory (ROM) 702 or a program loaded from a storage part 708 to a random access memory (RAM) 703, such as executing the methods described in the above embodiments. In the RAM 703, various programs and data necessary for the operation of the system are further stored. The CPU 701, the ROM 702, and the RAM 703 are connected to one another through a bus 704. An input/output (I/O) port 705 is also connected to the bus 704.

Following components are connected to an I/O port 705: an input part 706 including a keyboard, a mouse, etc.; an output part 707 including such as a cathode ray tube (CRT), a liquid crystal display (LCD), and a speaker, etc., a storage part 708 including a hard disk, etc.; and a communication part 709 including a network port card such as a LAN (Local Area Network) card, a modem, etc. The communication part 709 performs a communication processing through a network such as Internet. A driver 710 is also connected to the I/O port 705 as needed. A removable medium 711, such as a magnetic disk, an optical disk, a magneto-optical disk, a semiconductor memory, or the like, is mounted on the driver 710 as needed, so that a computer program read therefrom is installed into the storage part 708 as needed.

It should be noted that, the computer-readable medium shown in the embodiments of the disclosure may be a computer-readable signal medium or a non-transitory computer-readable storage medium or any combination of the two. The non-transitory computer-readable storage medium may be, for example, an electronic, magnetic, optical, electromagnetic, infrared, or semiconductor system, a system, or a device, or any combination of the above. More specific examples of non-transitory computer-readable storage medium may include, but are not limited to, an electrical connector with one or more conductive wires, a portable computer magnetic disk, a hard drive, a random access memory (RAM), a read-only memory (ROM), an erasable programmable read-only memory (EPROM), a flash memory, an optical fiber, a portable compact disc read-only memory (CD-ROM), an optical storage device, a magnetic storage device, or any suitable combination of the foregoing.

In this disclosure, the computer-readable signal medium may include a propagated data signal in a baseband or as part of a carrier wave, with a computer-readable computer program therein. Such a propagated data signal may take a variety of forms, including but not limited to electromagnetic signals, optical signals, or any suitable combination of the foregoing. Computer-readable signal medium may also be any computer-readable medium other than non-transitory computer-readable storage medium that may communicate, propagate, or transport a program for use by or in connection with an instruction execution system, system, or device. The computer program on the computer-readable medium may be transmitted using any appropriate medium, which includes but not limited to wireless, wired, etc., or any suitable combination of the foregoing.

The flowcharts and block diagrams in the accompanying drawings illustrate possible implementation architectures, functions, and operations of systems, methods, and computer program products according to various embodiments of the disclosure. Wherein, each box in the flowchart or block diagram may represent a module, a program segment, or a portion of code, which contains one or more executable instructions for implementing specified logical functions. It should also be noted that, in some alternative implementations, the functions noted in the block may occur out of the order noted in the figures. For example, two blocks shown in succession may actually be executed substantially in parallel, or they may sometimes be executed in a reverse order, depending on the functions involved. It should also be noted that each block in the block diagrams or flowcharts, and combinations of blocks in the block diagrams or flowcharts, may be implemented by a dedicated hardware-based system that performs specified functions or operations, or may be implemented by a combination of dedicated hardware and computer instructions.

Units involved in the embodiments of the disclosure may be implemented by software or hardware, and the units described may also be arranged in a processor. Wherein, names of these units do not in some cases constitute limitations on the units themselves.

The disclosure further provides the non-transitory computer-readable storage medium on the other hand. The computer program is stored on the non-transitory computer-readable storage medium, and when the computer program is executed by the processor of the computer, the non-transitory computer-readable storage medium enables the computer to implement the processing method for brightness compensation of the display screen mentioned above. The non-transitory computer-readable storage medium may be included in the electronic device described in the above embodiments, or may exist independently without being assembled into the electronic device.

In summary, the disclosure provides a processing method, system, device and medium for brightness compensation of the display screen, which obtains a sample data set and performs the linear regression processing on the sample data set to obtain the regression coefficient set, and then processes the real environment temperature and the real image average grayscale value according to the regression coefficient set to obtain the temperature to be compensated of the display screen, so as to enable the temperature of the display screen for compensation to be closer to the actual temperature, thereby reducing an error of the brightness compensation of the display screen through the temperature and improving a brightness compensation accuracy of the display screen.

In the description of this specification, the description with reference to terms “this embodiment”, “example”, “specific example”, etc. means that specific features, structures, materials or characteristics described in conjunction with the embodiment or example are included in at least one embodiment or example of the disclosure. In this specification, exemplary expressions of the above terms do not necessarily refer to the same embodiment or example. Furthermore, specific features, structures, materials, or characteristics described may be combined in any suitable manner in any one or more embodiments or examples.

The embodiments of the disclosure disclosed above are only used to help illustrate the disclosure. The examples are not intended to be exhaustive or to limit the disclosure to the specific embodiments described. Obviously, many modifications and variations may be made based on teachings of this specification. This specification selects and specifically describes these embodiments in order to better explain principles and practical applications of the disclosure, so that those skilled in the art can better understand and utilize the disclosure. The disclosure is limited only by the claims appended hereto along with their full scope and equivalents.

What is claimed is:

1. A processing method for brightness compensation of a display screen, comprising:
obtaining a sample data set of the display screen, a real environment temperature of the display screen and a real image average grayscale value corresponding to the real environment temperature, the sample data set comprising an environment temperature sample set, an image average grayscale sample set corresponding to the environment temperature sample set and a simulated temperature sample set;
performing a linear regression processing on the sample data set to generate a regression coefficient set;
processing the real environment temperature and the real image average grayscale value according to the regression coefficient set to generate a temperature to be compensated of the display screen; and
determining a brightness compensation parameter according to the temperature to be compensated, and performing a brightness compensation processing on the display screen according to the brightness compensation parameter.

2. The processing method for brightness compensation of a display screen according to claim 1, wherein, obtaining a sample data set of the display screen, a real environment temperature and a corresponding real image average grayscale value comprises:
obtaining the sample data set of the display screen;
obtaining the real environment temperature of the display screen; and
obtaining a resolution of the display screen and grayscale values of all pixels in a display image at the real environment temperature, and processing the resolution and the grayscale values to generate the real image average grayscale value.

3. The processing method for brightness compensation of a display screen according to claim 1, wherein, performing a linear regression processing on the sample data set to generate a regression coefficient set comprises:
respectively averaging the environment temperature sample set, the image average grayscale sample set and the simulated temperature sample set to generate an environment temperature average value, an image average grayscale average value and a simulated temperature average value;
processing the environment temperature sample set, the image average grayscale sample set and the simulated temperature sample set in sequence according to the environment temperature average value, the image average grayscale average value and the simulated temperature average value to generate an undetermined coefficient set; and
performing a binary linear regression processing on the undetermined coefficient set to generate the regression coefficient set.

4. The processing method for brightness compensation of a display screen according to claim 3, wherein, respectively averaging the environment temperature sample set, the image average grayscale sample set and the simulated temperature sample set satisfies a formula:
$$\overline{T} = \frac{1}{p * k} {\sum }_{i = 1}^{p * k} {T}_{i} ,$$
$$\overline{L} = \frac{1}{p * k} {\sum }_{i = 1}^{p * k} {L}_{i} ,$$
$$\overline{{T}_{OLED}} = \frac{1}{p * k} {\sum }_{i = 1}^{p * k} {T}_{{OLED}_{i}} ,$$
wherein, p represents a number of environment temperature samples in the environment temperature sample set, k represents a number of image average grayscale samples in the image average grayscale sample set, Tᵢ represents an i-th environment temperature sample in the environment temperature sample set, T̅ represents the environment temperature average value, Lᵢ represents an i-th image average grayscale sample in the image average grayscale sample set, L̅ represents the image average grayscale average value, T_{OLED}_{ᵢ} represents an i-th simulated temperature sample in the simulated temperature sample set, and T̅_̅{̅O̅L̅E̅D̅}̅ represents the simulated temperature average value.

5. The processing method for brightness compensation of a display screen according to claim 3, wherein, processing the environment temperature sample set, the image average grayscale sample set, and the simulated temperature sample in sequence according to the environment temperature average value, the image average grayscale average value and the simulated temperature sample set satisfies a formula:
$${l}_{11} = {\sum }_{i = 1}^{p * k} {( {L}_{i} - \overline{L} )}^{2} ,$$
$${l}_{22} = {\sum }_{i = 1}^{p * k} {( {T}_{i} - \overline{T} )}^{2} ,$$
$${l}_{12} = {l}_{21} = {l}_{11} = {\sum }_{i = 1}^{p * k} ( {L}_{i} - \overline{L} ) ( {T}_{i} - \overline{T} ) ,$$
$${l}_{10} = {l}_{11} = {\sum }_{i = 1}^{p * k} ( {L}_{i} - \overline{L} ) ( {T}_{{OLED}_{i}} - \overline{{T}_{OLED}} ) ,$$
$${l}_{20} = {\sum }_{i = 1}^{p * k} ( {T}_{i} - \overline{T} ) ( {T}_{{OLED}_{i}} - \overline{{T}_{OLED}} ) ,$$
wherein, p represents a number of environment temperature samples in the environment temperature sample set, k represents a number of image average grayscale samples in the image average grayscale sample set, Tᵢ represents an i-th environment temperature sample in the environment temperature sample set, T̅ represents the environment temperature average value, Lᵢ represents an i-th image average grayscale sample in the image average grayscale sample set, L̅ represents the image average grayscale average value, T_{OLED}_{ᵢ}represents an i-th simulated temperature sample in the simulated temperature sample set, and T̅_̅{̅O̅L̅E̅D̅}̅ represents the simulated temperature average value, l₁₁, l₂₂, l₁₂, l₂₁, l₁₀ and l₂₀ respectively represent undetermined coefficients in the undetermined coefficient set.

6. The processing method for brightness compensation of a display screen according to claim 3, wherein, the regression coefficient set comprises an image grayscale regression coefficient, an environment temperature regression coefficient and a temperature compensation coefficient, and performing a binary linear regression processing on the undetermined coefficient set satisfies a formula:
$$\{ \begin{matrix}{l}_{11} {C}_{1} + {l}_{12} {C}_{2} = {l}_{10} \\ {l}_{21} {C}_{1} + {l}_{22} {C}_{2} = {l}_{20}\end{matrix} ,$$
$${C}_{3} = \overline{{T}_{OLED}} - {C}_{1} \overline{L} - {C}_{2} \overline{T} ,$$
wherein, l₁₁, l₂₂, l₁₂, l₂₁, l₁₀ and l₂₀ respectively represent undetermined coefficients in the undetermined coefficient set, C₁ is the image grayscale regression coefficient, C₂ is the environment temperature regression coefficient, and C₃ is the temperature compensation coefficient.

7. The processing method for brightness compensation of a display screen according to claim 1, wherein, processing the real environment temperature and the real image average grayscale value according to the regression coefficient set satisfies a formula:
$${T}_{OLED}^{′} = {C}_{3} + {C}_{1} {L}^{′} + {C}_{2} {T}^{′}$$
Wherein, C₁ represents an image grayscale regression coefficient, C₁ represents an environment temperature regression coefficient, C₁ represents a temperature compensation coefficient, T′ represents the real environment temperature, L′ represents the real image average grayscale value, and T′_{OLED} represents the temperature to be compensated of the display screen.

8. A processing system for brightness compensation of a display screen, comprising:
a data acquisition module, the data acquisition module configured to obtain a sample data set of the display screen, a real environment temperature of the display screen and a corresponding real image average grayscale value, the sample data set comprising an environment temperature sample set, a corresponding image average grayscale sample set and a simulated temperature sample set;
a linear regression module, the linear regression module configured to perform a linear regression processing on the sample data set to generate a regression coefficient set;
a temperature generation module, the temperature generation module configured to process the real environment temperature and the real image average grayscale value according to the regression coefficient set to generate a temperature to be compensated of the display screen; and
a brightness compensation module, the brightness compensation module configured to determine a brightness compensation parameter according to the temperature to be compensated, and perform a brightness compensation processing on the display screen according to the brightness compensation parameter.

9. An electronic device, comprising:
one or more processors; and
a storage system, the storage system configured to store one or more programs, wherein, when the one or more programs are executed by the one or more processors, the storage system enables the electronic device to implement the processing method for brightness compensation of the display screen of claim 1.

10. A non-transitory computer-readable storage medium, wherein, a computer program is stored on the non-transitory computer-readable storage medium, when the computer program is executed by a processor of a computer, the computer is adapted to implement the processing method for brightness compensation of the display screen of claim 1.
